(19) United States
(12) Patent Application Publication
(10) Pub. No.: US 2024/0246313 A1
(43) Pub. Date: Jul. 25, 2024

(54) HEAT RESISTANT MATERIALS AND METHODS FOR MAKING THE SAME

(71) Applicant: DelStar Technologies, Inc., Alpharetta, GA (US)

(72) Inventors: Geoffrey Henstock, Greater Manchester (GB); Rebecca Wilson, Stalybridge (GB)

(21) Appl. No.: 18/418,639

(22) Filed: Jan. 22, 2024

Related U.S. Application Data
(60) Provisional application No. 63/440,505, filed on Jan. 23, 2023.

(51) Int. Cl. B32B 5/26; B32B 5/02; B32B 7/12

(52) U.S. Cl. CPC B32B 5/26; B32B 5/02; B32B 7/12; B32B 2250/02; B32B 2250/05; B32B 2255/02; B32B 2255/26; B32B 2262/101; B32B 2307/3065; B32B 2307/7376

(57) ABSTRACT

Composite materials are provided for protection against fire and thermal energy from sources of heat, while minimizing harmful emissions and health risks. A heat resistant composite material comprises a first cloth layer, a second cloth layer adhered to the first cloth layer and an expandable fire resistant material between the first and second cloth layers. The composite material includes an adhesive that bonds the first and second cloth layers together and is configured to melt or otherwise lose its adhesion at a threshold temperature level. This allows the fire resistant material to swell or expand in the area of the cloth layers that is subjected to a source of heat, while maintaining adhesion of the cloth layers in the areas not subject to such heat. Thus, the composite material will swell and absorb heat, while still remaining adhered to the substrate it is designed to protect.

### TECHNICAL FIELD

This description generally relates to heat resistant composite materials for resisting fire and/or absorbing thermal energy from sources of heat and methods for making such composite materials.

### BACKGROUND

Heat and fire retardant materials that resist burning and withstand heat to protect the interior of vehicles, buildings or individuals from fire, explosions or other sources of heat have been developed. These materials, for example, may include fire retardant coatings or materials, such as asbestos, magnesium oxide, gypsum, vermiculite, silicates and the like, or they may comprise non-combustible textiles, such as fiberglass cloth, polybenzimidazole fibers (PBI), Kevlar®, aramid, flame retardant cotton and melamine, or synthetic rubbers, such as neoprene.

Unfortunately, some of the most effective fire resistant materials, such as asbestos and halogenated, polymeric or organophosphate flame retardants, also come with potentially toxic health risks and/or harmful emissions. For example, most flame retardants are physically mixed with the materials in products rather than chemically bound to these materials Thus, they continually migrate out of the products and into the dust, food and water that individuals ingest and/or breath into their lungs. In some cases, the fire resistant materials are released as a product of their reaction with fire, which can also lead to health risks or emissions that may be harmful to the environment.

Another drawback with existing heat resistant materials is that they are typically relatively bulky and heavy, making them suboptimal for many applications. For example, among the threats military vehicles may typically face are landmines, mortar fire and IED attacks. For the military, any thermal protection it uses must be both effective and supremely practical. Therefore the military sector requires heat insulation solutions that will offer a safe, fire-proofing alternative to conventional materials, such as asbestos, but must also be lightweight and portable.

In another example, fires in electric vehicles powered by high-voltage lithium-ion batteries pose a danger to the occupants of the vehicle as well as the risk of electric shock to emergency responders. These batteries, however, are relatively small and generally fit within confined spaces in the vehicles. Heat resistant materials for the battery casings must, therefore, be lightweight and compact to protect the vehicle from battery fires, while avoiding a reduction in the overall performance of the vehicle.

What is needed, therefore, are improved heat resistant materials that provide effective protection against fire and thermal energy from sources of heat, while minimizing harmful emissions and health risks. It would be particularly desirable to provide lightweight, portable and compact materials that can be used in a variety of applications, such as protecting military vehicles, electric batteries, buildings, individuals and the like.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Composite heat resistant materials and methods for making such materials are provided. In one aspect, a heat resistant composite material comprises a first cloth layer, a second cloth layer adhered to the first cloth layer and an expandable fire resistant material between the first and second cloth layers, coated onto at least one of the cloth layers or incorporated within at least one of the cloth layers. The composite material is thin, lightweight and flexible and relatively inexpensive to manufacture, while also releasing a very low (or zero) amount of harmful chemicals when exposed to fire or excessive heat. The materials may be used as a protective covering for a substrate or surface in a variety of applications, such as vehicles (e.g., military vehicles), electric batteries, buildings, insulation blankets, protective clothing, cargo nets, hospital drapes, sheets or mattress covers, and the like.

In embodiments, the composite material includes an adhesive that bonds the first and second cloth layers together. The adhesive is configured to melt or otherwise lose its adhesion at a threshold temperature level. This allows the fire resistant material to swell or expand in the area of the cloth layers that is subjected to a source of heat, while maintaining adhesion of the cloth layers in the areas not subject to such heat. Thus, the composite material will swell and absorb heat, while still remaining adhered to the substrate it is designed to protect.

In embodiments, the adhesive melts or otherwise loses adhesion between the first and second layers at a temperature at or above about 30 degrees C., preferably at or above about 60 degrees C. Suitable adhesives include fabric or wood glue epoxies, cyanoacrylates, urethanes, acrylics, hot-melt adhesives, pressure-sensitive adhesives, reactive adhesives, wet adhesives, solvent-based adhesives, rubber-based adhesives contact adhesives and the like. In a preferred embodiment, the adhesive comprises fabric or wood glue.

The adhesive may be applied to one or both of the first and second layers. In certain embodiments, the composite comprises at least two layers of adhesive, one layer being applied between the fire resistant material and the first outer layer of cloth, and the other layer being applied between the fire resistant material and the second outer layer of cloth. In another embodiment, the fire resistant material is mixed or otherwise incorporated into one or both of the outer layers of cloth. In this embodiment, the composite may comprise a single layer of adhesive between the first and second outer layers of cloth.

The fire resistant material is configured to expand or swell upon the application of heat to the fire resistant material. Suitable materials for the fire resistant material include melamine, melamine polyphosphate, aluminium trihydroxide, antimony trihydroxide, phosphorous, ammonium polyphosphate, halogenated organic materials, PBDE, TBBPA, mica and mica derivatives, vermiculite and vermiculite derivatives, basalt, graphite, polybutylene terephthalate and combinations thereof. In a preferred embodiment, the fire resistant material includes vermiculite, vermiculite derivatives, basalt, graphite or combinations thereof.

The outer cloth layers may comprise any material suitable for providing a covering or protective layer on a surface. Suitable materials for the cloth layers include glass, glass fiber, glass fiber mats, fiberglass, glass cloth, woven or non-woven fabric, and the like. In a preferred embodiment, the outer layers comprise glass, fiberglass or glass cloth.

The composite material may have an overall thickness of about 0.05 mm to about 1.0 mm, or about 0.1 to about 0.3 mm, preferably about 0.2 mm. The material may have a weight of less than about 200 kg/m2 or about 600 kg/m2 to about 1000 kg/m2.

In embodiments, the fire resistant material is incorporated into first and second glass cloth layers by blending the fire resistant material with one or more materials that provide adherence between the fire resistant material and the glass cloth layers. In one such embodiment, the fire resistant material is blended with a polymer to form a composition that adheres to the cloth layers. The composition may, or may not, include an additional binder material to facilitate binding between the fire resistant material and the cloth layers.

In an exemplary embodiment, the composition includes about 0.5 grams/m2 to about 10 grams/m2 of the binder material, preferably about 1 gram/m2 to about 4 grams/m2 and more preferably about 2 grams/m2. The ability to maintain a substantially low amount of binder in the composition reduces the amount of material that is released into the environment when exposed to fire or excessive heat.

In another aspect, a heat resistant composite material comprises a first cloth layer, a second cloth layer adhered to the first cloth layer and an expandable fire resistant material between the first and second cloth layers, coated onto at least one of the cloth layers or incorporated within at least one of the cloth layers. In this “military grade” embodiment, the composite material is configured to absorb a significant amount of heat or fire that a military vehicle may be subjected to. In particular, the heat resistant material may be capable of absorbing or resisting a temperature of about 1100° C. for extended periods.

In embodiments, the heat resistant material comprises a blend of vermiculite, clay and aluminium trihydroxide.

The recitation herein of desirable objects which are met by various embodiments of the present description is not meant to imply or suggest that any or all of these objects are present as essential features, either individually or collectively, in the most general embodiment of the present description or in any of its more specific embodiments.

### BRIEF DESCRIPTION OF THE DRAWINGS

FIG. 1 illustrates a heat resistant composite material

FIG. 2 illustrates the material of FIG. 1 with the central portion expanded after heating;

FIG. 3 illustrates another embodiment of a heat resistant composite material; and

FIG. 4 illustrates testing data from a heat resistant composite material described herein.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Composite heat resistant materials and methods for making such materials are provided. The composite materials described herein are relatively inexpensive to manufacture and they are designed to release a very low (or zero) amount of harmful chemicals when exposed to heat or fire, thereby minimizing harmful emissions and health risks. In addition, the material is thin, flexible and lightweight and may be used as a protective covering for a substrate or surface in a variety of applications, such as building and construction materials, including wires, cables, insulation materials and the like, welding applications, aerospace and marine safety, fire prevention and inhibiting heat and/or fire from entering or escaping from vehicles, aircraft, marine vessels, electric batteries, buildings, insulation blankets, protective clothing, mattresses, cargo nets, hospital drapes, sheets or mattress covers, transportation products, such as seats, seat covers and fillings, bumpers, overhead compartments and other parts of automobiles, airplanes and trains, electronics and electrical devices, such as computers, laptops, phones, televisions and household appliances, furnishings, such as foam, upholstery, mattresses, carpets, curtain, fabric blinds and the like.

In one embodiment, the materials disclosed herein are configured to use in military applications, such as tanks, Humvees, armored trains, reconnaissance vehicles, self-propelled anti-aircraft or artillery vehicles, tactical vehicles, trucks, helicopters, aircraft, armored personnel carriers and other armored vehicles, to protect the interior of the vehicle or aircraft with the heat associated with a projectile or other high temperature round being fired at the vehicle or aircraft. In this embodiment, the composite materials may be secured to, or incorporated within, the inner or outer surface of the vehicle's body or frame. The composite materials may be secured in any manner suitable to those of skill in the art, such as by applying an epoxy, glue or other adhesive between the composite material and the vehicle frame. Suitable adhesives include cyanoacrylate-based adhesives and epoxies, Pratley® epoxy glue, epoxy steel putty, polyurethane-based glues, ethyl cyanoacrylate (CA) and the like.

In one such embodiment, a vehicle cover is provided that includes the composite materials described herein. The vehicle cover may be removable from the vehicle during use, or it may be configured to be secured to the vehicle during use (i.e., such that the cover does not extend across windows or other portions of the vehicle that must be uncovered during use). The vehicle cover may comprise any suitable material and may include multiple layers of materials. The composite materials may be incorporated into one of the layers, and/or sandwiched between one or more layers of the cover.

Alternatively, the composite materials may be configured for use to increase the safety of the interior portions of vehicles or aircrafts, such as seats, internal frames, instrument panels, seat covers and fillings, bumpers, overhead compartments, the engine compartment, the hollow spaces between the interior and outer sheet metal of vehicles and the like. The composite materials may be secured to an outer or inner surface of these interior structures, or incorporated within the materials used to form these structures. For example, traditional seating materials consist of a multi-layered or homogeneous seat, either molded or contour, cut from a series of commercial grade polyurethane foams. These foams have high resiliency and are designed as excellent cushions and used across a broad spectrum of automotive, truck, and commercial seating. Military seat cushions utilizing this same construction with polyurethane foam may include the composite materials disclosed herein to increase the heat resistance of these seats.

In another embodiment, the materials may be configured for use on, or in, camouflage materials, such as woven layers, knits, twills, fleece, non-wovens, staple-length fibers, continuous filaments, yarns, tapes and combinations thereof. The camouflage materials may, for example, include garments, tents, military gear and the like. The composite materials may be secured to an outer or inner surface of these materials, or incorporated within the materials.

In one such embodiment, a garment is provided with heat or flame resistant properties. The garment has a shape to cover at least a portion of the wearer's body. The garment includes the composite materials described herein, and may also include other materials, such as woven or nonwoven fabric. The fabric may contain additional flame or heat resistant fibers, such as flame resistant cellulose fibers, meta-aramid fibers, para-aramid fibers, fiber resistant viscose (FR viscose) and the like.

In another embodiment, the composites materials described herein are configured for use with a flame or heat resistant mattress. The materials may be configured to cover at least a portion of the surface of the mattress and may be combined with additional flame or heat resistant fibers, such as flame resistant cellulose fibers, meta-aramid fibers, para-aramid fibers, fiber resistant viscose (FR viscose) and the like.

In another embodiment, the materials described herein are configured for use with building and construction materials, including wires, cables, insulation materials, windows, doors, walls, floors, roofs, internal beams, columns and slabs, and the like. In this embodiment, the composite materials may be secured to an outer or inner surface of the structures, or incorporated within the materials used for the structures. For example, the composite materials may be incorporated within building insulation, such as fiberglass, foam board, spray foam, cellulose, injection foam or the like. Alternatively, the composite materials may be secured to the surfaces of these structures with a suitable adhesive, such adhesive tapes (e.g., pressure sensitive tapes, glass cloth adhesive tape), an epoxy, glue, cyanoacrylate-based adhesives and epoxies, polyurethane-based glues, Jeweler's glue (e.g., E600 or Beacon 527 glues), silicone gel glues and the like.

In another embodiment, these materials are configured for use to protect electronic equipment from high temperature. In one such embodiment, the composite materials are specifically designed for use in protecting batteries from high temperatures outside of the battery case or within the battery itself (e.g. temperatures associated with, for example, exploding lithium batteries). In this embodiment, the composite materials may be secured to the inner or outer surface of the battery case with a suitable adhesive, such as an epoxy glass prepreg or other suitable adhesives described above. Alternatively, the composite materials may be incorporated into the material used to form the battery case, such as polypropylene resin, carbon fiber reinforced (CFRP), glass fiber reinforced plastic (GFRP), reinforcing textiles, metalized plastic films, aluminum and aluminum alloys, other metal alloys and the like.

In another embodiment, the composite materials are configured for use to provide additional thermal insulation for pipes, blankets, personal protective apparel and other thermal insulation and fire protection products. In this embodiment, the composite materials may be applied to, or used in conjunction with, heat resistant fabrics, such as woven fiberglass fabrics, aluminized fabrics, welding blankets and the like. Alternatively, the composite materials may be incorporated into one or more of these heat resistant fabrics.

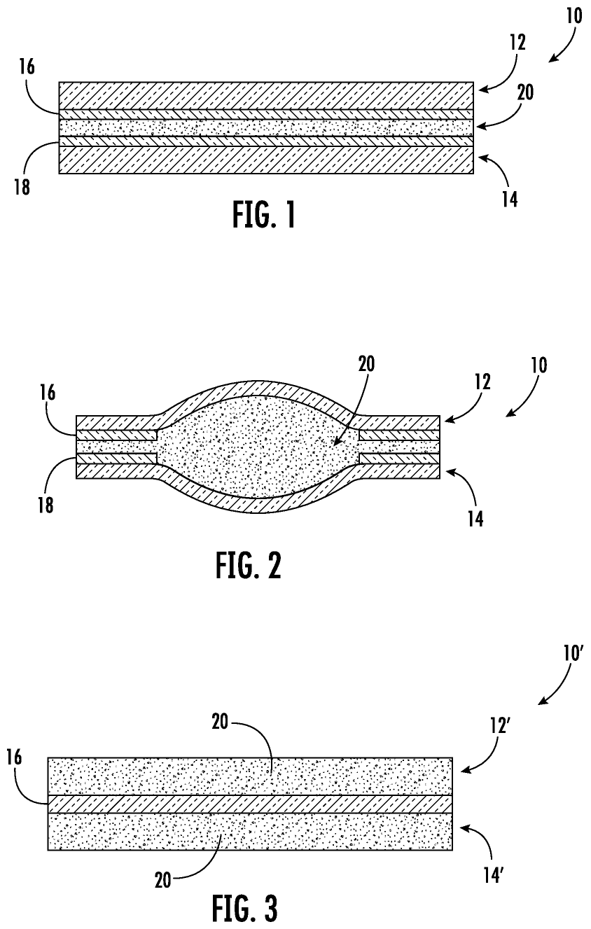

Referring now to FIG. 1, a heat resistant composite material 10 comprises first and second outer layers 12, 14 and a heat resistant material 20 therebetween. Material 10 further comprises at least one adhesive layer 16 between inner and outer layers 12, 14. In some embodiments, material 20 may include a second adhesive layer 18. In other embodiments, adhesive layers 16 and 18 are formed together as one layer. Adhesive layer(s) 16, 18 may bond outer layers 12, 14 directly to each other, or they may bond outer layers 16, 18 to heat resistant material 20 (as shown in FIG. 1).

FIG. 2 illustrates composite material 10 upon the application of sufficient heat to a central portion of composite material 10. As shown, adhesive layers 16, 18 have melted away in the central portion of material 10. This removes the bond between outer layers 12, 14 and allows fire resistant material 20 to expand or swell and absorb a substantial portion of the heat. At the same time, the outer portions of adhesive layers 16, 18 that have not been subject to sufficient heat to melt, remained adhered to outer layers 12, 14. This ensures that the composite material will remain substantially intact and adhered to the surface it was designed to protect.

FIG. 3 illustrates another embodiment of a composite material 10′. As shown, composite material 10′ comprises inner and outer layers 12′, 14′ and an adhesive layer 16 therebetween. A fire resistant material 20 is incorporated or mixed into one or both of outer layers 12′, 14′. Similar to the previous embodiment, adhesive layer 16 is configured to melt or otherwise lose its adherence at or above certain temperatures.

As with previous embodiments, upon the application of sufficient heat to a portion of composite material 10, adhesive layer 16 melts or otherwise loses its adherence so that layers 12′, 14′ may separate from each other in that portion of the material 10. This, in turn, allows heat resistant material 20 to expand or swell to absorb the applied heat.

Composite material 10, 10′ may each have an overall thickness of about 0.05 mm to about 1.0 mm, or about 0.1 to about 0.3 mm, preferably about 0.2 mm. The thickness of composite material 10, 10′ may depend on the particular application and the amount of heat that will be absorbed by the material. It is envisaged that a temperature differential (ΔT) of between 200° C. (0.05 mm) and 1000° ° C. (military grade) will be noted between the side exposed to fire and the reverse side. The material may have a thickness of about 0.7 to about 1.0 mm.

Outer layers 12, 14 may comprise any material suitable for providing a covering or protective layer on a surface. Suitable materials for outer layers 12, 14 include glass, glass fiber, glass fiber mats, fiberglass, glass cloth, woven or non-woven fabric, tapes and the like. In a preferred embodiment, outer layers 12, 14 comprise glass, fiberglass or glass cloth.

Adhesive layers 16, 18 comprise a material that is configured to melt or otherwise lose its adherence at or above certain temperatures. In certain embodiments, the material is particularly configured to melt or otherwise lose its adherence at temperatures at or above about 30 degrees C., preferably at or above about 60 degrees C. Suitable materials for adhesive layer(s) include fabric or wood glue, epoxies, cyanoacrylates, urethanes, acrylics, hot-melt adhesives, pressure-sensitive adhesives, reactive adhesives, wet adhesives, solvent-based adhesives, rubber-based adhesives contact adhesives and the like. In a preferred embodiment, adhesive layers comprise fabric or wood glue.

Heat resistant material 20 may comprise any suitable material capable of expanding or swelling to absorb heat. Suitable materials include, but at not limited to, melamine, melamine polyphosphate, aluminium trihydroxide, antimony trihydroxide, phosphorous, ammonium polyphosphate, halogenated organic materials, PBDE, TBBPA, mica and mica derivatives, vermiculite and vermiculite derivatives, basalt, graphite, polybutylene terephthalate and combinations thereof. In a preferred embodiment, the fire resistant material includes vermiculite, vermiculite derivatives, basalt, graphite or combinations thereof.

Fire resistant material 20 may be applied as a layer between inner and outer layers 12, 14, or it may be incorporated into, or coated onto, each of these layers. In one embodiment, fire resistant material is incorporated into first and second glass cloth layers by blending the fire resistant material with one or more materials that provide adherence between the fire resistant material and the glass cloth layers. In certain embodiments, the fire resistance material is blended with a polymer, such as polyvinyl alcohol (PVOH), acrylic, styrene-butadiene (SBR) or combinations thereof, and may, or may not, include an additional binder material.

In an exemplary embodiment, the material 20 includes about 0.5 grams/m2 to about 10 grams/m2 of binder, preferably about 1 gram/m2 to about 4 grams/m2 and more preferably about 2 grams/m2. Suitable materials for the binder include PVOH, acrylics, SBR and combinations thereof.

Applicant has discovered that by blending the fire resistant material with a polymer such as polyvinyl alcohol (PVOH), acrylic and/or styrene-butadiene (SBR), and contains little to no binder, this reduces the amount of material that is released from fire resistant material upon the application of heat, particularly when composite material has been exposed to fire or excessive heat.

In embodiments, the three layers of lamination are bonded with two layers of adhesive. The materials from outer layers, 12, 14 may include woven and non-woven glass and are therefore difficult to bond easily. The intumescent material in heat resistant layer 20 is also slightly rough, which makes it more difficult to bond these materials together.

In certain embodiments, a higher grade material may be used for outer layers 12, 14 to increase the heat resistance of the composition for use, for example, in military applications. In these embodiments, outer layers 12, 14 may comprise a higher intumescent graphite coating on a basalt backing, which results in a thicker and tougher composition.

### Examples

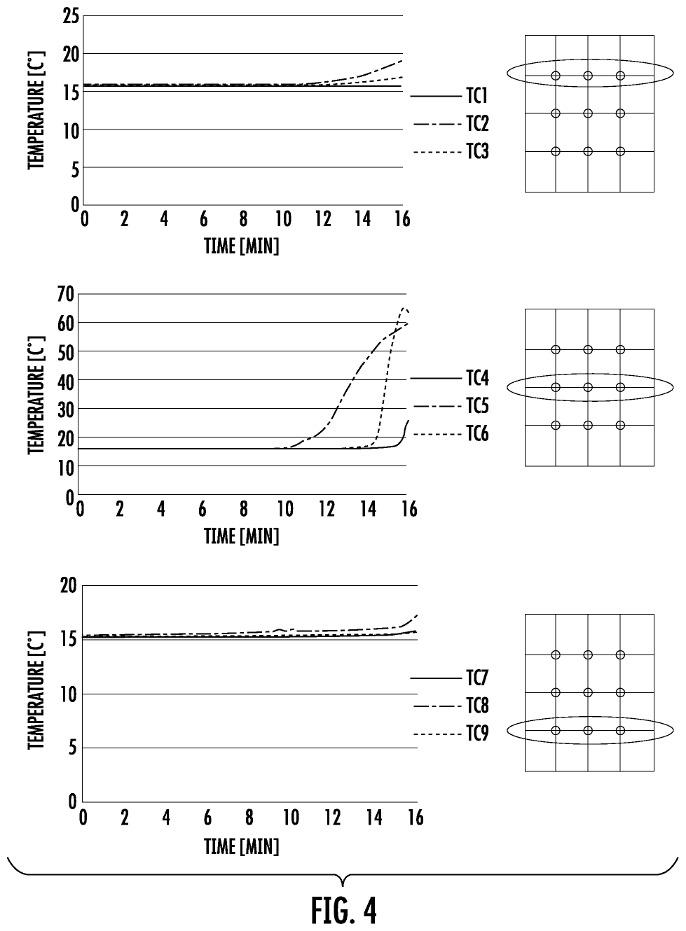

FIG. 4 illustrates the results of testing Applicant conducted on a composite material having outer layers 12, 14 of glass fabric and a heat resistant layer 20 comprising vermiculite. The outer layers were adhered together with wood glue. The composite material was exposed to a fire. Nine separate thermocouples (labeled TC1-TC9) were positioned near the reverse side of the composite material from the fire with a 50 mm air gap.

The graphs on the left side of FIG. 4 illustrate the temperature changes over time for the material for each thermocouple. As shown, the thermocouples at the center of the fire (i.e., TC4-TC6) remained at a substantially constant temperature of about 15° C. for about ten minutes, and then began to increase in temperature. The thermocouples on either side of the fire (TC1-TC3 and TC7-TC9) remained at a substantially constant temperature of about 15° C. and only increased in temperature by about 5° C. or less at 16 minutes.

The wood glue at the center of the fire (i.e., located around TC4-TC6) loses its adhesion at about 60° C. Therefore, the adhesive began to melt or otherwise lose its adhesion at the center of the fire, which allowed the fire resistant material to swell or expand in the area of the cloth layers that were subjected to a source of heat. At the same time, the wood glue one either side of the fire (i.e., located at TC1-TC3 and TC7-TC9) maintained adhesion of the cloth layers in the areas not subject to such heat. Thus, the composite material swelled and absorbed heat at the center of the fire, while still remaining adhered to the substrate it was designed to protect.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a heat resistant composite material comprising a first cloth layer, a second cloth layer in contact with the first cloth layer and an expandable fire-resistant material between the first and second cloth layers.

A second embodiment is the first embodiment wherein the first cloth layer is adhered to the second cloth layer.

A third embodiment is any combination of the first 2 embodiments, wherein the first and second cloth layers comprise glass.

A 4^{th} embodiment is any combination of the first 3 embodiments, wherein the first and second cloth layers comprise fiberglass.

A 5^{th} embodiment is any combination of the first 4 embodiments, wherein the fire-resistant material is configured to expand upon the application of heat to the fire-resistant material.

A 6^{th} embodiment is any combination of the first 5 embodiments, wherein the fire-resistant material comprises a material selected from the group consisting of melamine, melamine polyphosphate, aluminum trihydroxide, antimony trihydroxide, phosphorous, ammonium polyphosphate, halogenated organic materials, PBDE, TBBPA, mica and mica derivatives, vermiculite and vermiculite derivatives, basalt, graphite, polybutylene terephthalate and combinations thereof.

A 7^{th} embodiment is any combination of the first 6 embodiments, wherein the fire-resistant material comprises vermiculite.

An 8^{th} embodiment is any combination of the first 7 embodiments, wherein the fire-resistant material comprises basalt.

A 9^{th} embodiment is any combination of the first 8 embodiments, further comprising an adhesive between the first and second layers.

A 10^{th} embodiment is any combination of the first 9 embodiments, wherein the adhesive substantially loses adhesion between the first and second layers at a temperature of about 60 degrees C. or greater.

An 11^{th} embodiment is any combination of the first 10 embodiments, wherein the adhesive comprises fabric or wood glue.

A 12^{th} embodiment is any combination of the first 11 embodiments, further comprising a polymer mixed with the fire-resistant material.

A 13^{th} embodiment is any combination of the first 12 embodiments, wherein the polymer is selected from a group consisting of polyvinyl alcohol (PVOH), acrylic, styrene-butadiene (SBR) and combinations thereof.

A 14^{th} embodiment is any combination of the first 13 embodiments, wherein the fire-resistant material further comprises graphite.

A 15^{th} embodiment is any combination of the first 14 embodiments, wherein the fire-resistant material further comprises basalt.

A 16^{th} embodiment is any combination of the first 15 embodiments, further comprising a binder between the first and second layers, wherein the binder is less than about 2 grams/m2 area of the first and second layers.

A 17^{th} embodiment is any combination of the first 16 embodiments, wherein the composite material has a thickness of less than about 0.05 mm to about 1.0 mm.

An 18^{th} embodiment is any combination of the first 17 embodiments, wherein the first and second cloth layers each comprise a first surface and a second surface opposite the first surface, wherein the first surface of the first cloth layer is adhered to the second surface of the second cloth layer.

A 19^{th} embodiment is any combination of the first 18 embodiments, wherein the fire-resistant material is applied as a coating to the first surface of the first cloth layer.

A 20^{th} embodiment is any combination of the first 19 embodiments, wherein the fire-resistant material is applied as a coating to the second surface of the second cloth layer.

A 21^{st} embodiment is any combination of the first 20 embodiments, wherein the fire-resistant material is incorporated into at least one of the first and second cloth layers.

In another aspect, a first embodiment is a heat resistant composite material comprising first and second layers in contact with each other. A first portion of the first and second layers is configured to separate from each other when a threshold amount of heat is applied to the first portion and a second portion of the first and second layers is configured to remained adhered to each other when the threshold amount of heat is applied to the first portion.

A second embodiment is the first embodiment wherein the first layer is adhered to the second layer.

A third embodiment is any combination of the first 2 embodiments, wherein the threshold amount of heat is a temperature of about 30 degrees C. or greater.

A 4^{th} embodiment is any combination of the first 3 embodiments, wherein the threshold amount of heat is a temperature of about 60 degrees C. or greater.

A 5^{th} embodiment is any combination of the first 4 embodiments, further comprising an adhesive between the first and second layers, wherein the adhesive substantially loses adhesion between the first and second layers at a temperature of about 60 degrees C. or greater.

A 6^{th} embodiment is any combination of the first 5 embodiments, wherein the adhesive comprises fabric or wood glue.

A 7^{th} embodiment is any combination of the first 6 embodiments, wherein the first and second cloth layers comprise glass or fiberglass.

An 8^{th} embodiment is any combination of the first 7 embodiments, further comprising an expandable fire-resistant material configured to expand upon the application of heat to the fire-resistant material.

A 9^{th} embodiment is any combination of the first 8 embodiments, wherein the fire-resistant material comprises a material selected from the group consisting of melamine, melamine polyphosphate, aluminium trihydroxide, antimony trihydroxide, phosphorous, ammonium polyphosphate, halogenated organic materials, PBDE, TBBPA, mica and mica derivatives, vermiculite and vermiculite derivatives, basalt, graphite, polybutylene terephthalate and combinations thereof.

A 10^{th} embodiment is any combination of the first 9 embodiments, wherein the fire-resistant material comprises vermiculite.

An 11^{th} embodiment is any combination of the first 10 embodiments, further comprising a binder between the first and second layers, wherein the binder is less than about 2 grams/m2 area of the first and second layers.

A 12^{th} embodiment is any combination of the first 11 embodiments, wherein the composite material has a thickness of less than about 1.0 mm.

A 13^{th} embodiment is any combination of the first 12 embodiments, wherein the first and second cloth layers each comprise a first surface and a second surface opposite the first surface, wherein the first surface of the first cloth layer is adhered to the second surface of the second cloth layer.

A 14^{th} embodiment is any combination of the first 13 embodiments, wherein the fire-resistant material is applied as a coating to the first surface of the first cloth layer.

A 15^{th} embodiment is any combination of the first 14 embodiments, wherein the fire-resistant material is applied as a coating to the second surface of the second cloth layer.

A 16^{th} embodiment is any combination of the first 15 embodiments, wherein the fire-resistant material is incorporated into at least one of the first and second cloth layers.

In another aspect, a first embodiment is a composite material for use with a vehicle. The composite material comprises a first cloth layer, a second cloth layer adhered to the first cloth layer and an expandable fire-resistant material between the first and second cloth layer.

A second embodiment is the first embodiment, wherein the material is configured for incorporation into a structure of the vehicle.

A 3^{rd} embodiment is any combination of the first 2 embodiments, further comprising an adhesive configured to secure the composite material to a surface of a structure of the vehicle.

In another aspect, a first embodiment is a composite material for use with a building structure. The composite material comprises a first cloth layer, a second cloth layer adhered to the first cloth layer and an expandable fire-resistant material between the first and second cloth layer.

A second embodiment is the first embodiment, wherein the material is configured for incorporation into a structure of the building.

A third embodiment is any combination of the first 2 embodiments, wherein the material is configured for incorporation into an insulation material of the building.

A 4^{th} embodiment is any combination of the first 3 embodiments, further comprising an adhesive configured to secure the composite material to a surface of a structure of the building.

In another aspect, a first embodiment is a composite material for use with a battery. The composite material comprises a first cloth layer, a second cloth layer adhered to the first cloth layer and an expandable fire-resistant material between the first and second cloth layer.

A second embodiment is the first embodiment wherein the material is configured for incorporation into a casing of the battery.

A third embodiment is any combination of the first 2 embodiments, further comprising an adhesive configured to secure the composite material to a surface of a casing of the battery.

In another aspect, a first embodiment is a composite material for use with a garment. The composite material comprises a first cloth layer, a second cloth layer adhered to the first cloth layer and an expandable fire-resistant material between the first and second cloth layer.

A second embodiment is the first embodiment wherein the composite material is configured for incorporation into the garment.

What is claimed is:

1. A heat resistant composite material comprising:
a first cloth layer;
a second cloth layer in contact with the first cloth layer; and
an expandable fire-resistant material between the first and second cloth layers.

2. The composite material of claim 1, wherein the first cloth layer is adhered to the second cloth layer.

3. The composite material of claim 1, wherein the first and second cloth layers comprise glass or fiberglass.

4. The composite material of claim 1, wherein the fire-resistant material is configured to expand upon the application of heat to the fire-resistant material.

5. The composite material of claim 1, wherein the fire-resistant material comprises a material selected from the group consisting of melamine, melamine polyphosphate, aluminium trihydroxide, antimony trihydroxide, phosphorous, ammonium polyphosphate, halogenated organic materials, PBDE, TBBPA, mica and mica derivatives, vermiculite and vermiculite derivatives, basalt, graphite, polybutylene terephthalate and combinations thereof.

6. The composite material of claim 1, wherein the fire-resistant material comprises vermiculite.

7. The composite material of claim 1, wherein the fire-resistant material comprises basalt.

8. The composite material of claim 1, further comprising an adhesive between the first and second layers, wherein the adhesive substantially loses adhesion between the first and second layers at a temperature of about 60 degrees C. or greater.

9. The composite material of claim 7, wherein the adhesive comprises fabric or wood glue.

10. The composite material of claim 1, further comprising a polymer mixed with the fire-resistant material, wherein the polymer is selected from a group consisting of polyvinyl alcohol (PVOH), acrylic, styrene-butadiene (SBR) and combinations thereof.

11. The composite material of claim 6, wherein the fire-resistant material further comprises graphite or basalt.

12. The composite material of claim 1, further comprising a binder between the first and second layers, wherein the binder is less than about 2 grams/m² area of the first and second layers.

13. The composite material of claim 1, wherein the composite material has a thickness of less than about 0.05 mm to about 1.0 mm.

14. The composite material of claim 1, wherein the fire-resistant material is applied as a coating to a surface of the first cloth layer.

15. The composite material of claim 1, wherein the fire-resistant material is incorporated into at least one of the first and second cloth layers.

16. A heat resistant composite material comprising:
first and second layers in contact with each other;
wherein a first portion of the first and second layers is configured to separate from each other when a threshold amount of heat is applied to the first portion; and
wherein a second portion of the first and second layers is configured to remained adhered to each other when the threshold amount of heat is applied to the first portion.

17. The composite material of claim 16, wherein the first layer is adhered to the second layer.

18. The composite material of claim 16, wherein the threshold amount of heat is a temperature of about 30 degrees C. or greater.

19. The composite material of claim 16, wherein the threshold amount of heat is a temperature of about 60 degrees C. or greater.

20. The composite material of claim 16, further comprising an adhesive between the first and second layers, wherein the adhesive substantially loses adhesion between the first and second layers at a temperature of about 60 degrees C. or greater.

21. The composite material of claim 20, wherein the adhesive comprises fabric or wood glue.

22. The composite material of claim 16, wherein the first and second cloth layers comprise glass or fiberglass.

23. The composite material of claim 16, further comprising an expandable fire-resistant material configured to expand upon the application of heat to the fire-resistant material.

24. The composite material of claim 23, wherein the fire-resistant material comprises a material selected from the group consisting of melamine, melamine polyphosphate, aluminium trihydroxide, antimony trihydroxide, phosphorous, ammonium polyphosphate, halogenated organic materials, PBDE, TBBPA, mica and mica derivatives, vermiculite and vermiculite derivatives, basalt, graphite, polybutylene terephthalate and combinations thereof.

25. The composite material of claim 23, wherein the fire-resistant material comprises vermiculite.
